(19) United States
(12) Patent Application Publication
(10) Pub. No.: US 2025/0171120 A1
(43) Pub. Date: May 29, 2025

(54) METHOD FOR EVALUATING ANCHORAGE STATE AND DEVICE THEREOF

(71) Applicant: WUHAN UNIVERSITY OF TECHNOLOGY, WUHAN (CN)

(72) Inventors: FAN ZHANG, WUHAN (CN); CHUNHUI ZHOU, WUHAN (CN); JUNNAN ZHAO, WUHAN, HUBEI (CN); ZONGYANG LIU, WUHAN (CN); LANGXIONG GAN, WUHAN (CN); YANMIN XU, WUHAN (CN)

(21) Appl. No.: 19/036,721

(22) Filed: Jan. 24, 2025

Related U.S. Application Data
(63) Continuation-in-part of application No. 17/901,868, filed on Sep. 2, 2022.
Application No. 17/901,868 is a continuation of application No. PCT/CN2021/113468, filed on Aug. 19, 2021.

(30) Foreign Application Priority Data
Dec. 29, 2020 (CN) 202011595861.0

(51) Int. Cl. B63B 79/20; G01C 21/20

(52) U.S. Cl. CPC B63B 79/20; G01C 21/203

(57) ABSTRACT

A method for evaluating an anchorage state includes steps of obtaining ship trajectories of ships within a certain time period in an anchorage; screening out ship trajectories including an anchoring process and eliminating trajectory points in a non-anchored state in the ship trajectories to obtain anchoring trajectories of anchored ships; clustering anchoring points in each of the anchoring trajectories, using a cluster center as an anchoring position point of each of the anchored ships; establishing an anchoring data set according to the anchoring position points; selecting anchoring data records in a predetermined time period in the anchoring data set; establishing an anchored ship position point set corresponding to the predetermined time period; and establishing Thiessen polygons corresponding to the anchoring position points; calculating an area of each of the Thiessen polygons to obtain an anchoring area of a corresponding anchored ship.

### TECHNICAL FIELD

The present disclosure relates to a technical field of anchorage state evaluation, and in particular to a method for evaluating an anchorage state, a device thereof, and a computer storage medium thereof.

### BACKGROUND

During operation of the inland port anchorage, there are many anchored ships, and the anchorage is extremely crowded. An anchoring area actually occupied by each of the anchored ships reflects a safety degree of the anchorage of the anchored ships. At present, there is still no effective measurement method for the anchoring area of each of the anchored ships.

Although the “General Design Specification for River Ports” gives calculation formulas of the anchoring area of an anchored ship under conditions of different anchoring methods in inland waters. However, there are few studies on ship anchoring area in inland waters. Calculation of the anchoring area of the anchored ships in the “General Design Specification for River Ports” is only to give certain value parameters and corresponding empirical formulas in a general manner, which lacks a clear theoretical basis and cannot adapt to demands of a development trend of inland waterway shipping.

### SUMMARY

In view of this, it is necessary to provide a method and device for evaluating an anchorage state, to solve a problem that an anchoring area of a ship cannot be effectively measured.

The present disclosure provides a method for evaluating an anchorage state. The method comprises following steps:
obtaining ship trajectories of ships within a certain time period in an anchorage from a local Vessel Traffic Service system (VTS);
screening out ship trajectories including an anchoring process and eliminating trajectory points in a non-anchored state in the ship trajectories including the anchoring process to obtain anchoring trajectories of anchored ships;
clustering anchoring points in each of the anchoring trajectories, and using a cluster center of the anchoring points of each of the anchoring trajectories as an anchoring position point of each of the anchored ships;
establishing an anchoring data set according to the anchoring position point of each of the anchored ships; selecting anchoring data records in a predetermined time period in the anchoring data set; and establishing an anchored ship position point set corresponding to the predetermined time period;
establishing Thiessen polygons one-to-one corresponding to the anchoring position points in the anchored ship position point set; calculating an area of each of the Thiessen polygons to obtain an anchoring area of a corresponding anchored ship; and
determining a congestion level of the ships in the anchorage and a utilization rate of the anchorage based on a comparison result of the anchoring area of the corresponding anchored ship and a threshold specification area;

Furthermore, the step of obtaining the ship trajectories of the ships within the certain time period in the anchorage comprises:
obtaining Automatic Identification System (AIS) data of each of the ships within the certain time period in the anchorage; wherein the AIS data of each of the ships comprises static information and dynamic information; the dynamic information of each of the ships comprises ship position information, ship speed information, and heading information; and
generating the ship trajectories according to the ship position information, the ship speed information, and the heading information of each of the ships; and marking each of the ship trajectories of each of the ships based on the static information of each of the ships.

Furthermore, the step of obtaining the ship trajectories of the ships within the certain time period in the anchorage further comprises:
screening out and eliminating the trajectory points in the ship trajectories where ship positions are not within a predetermined anchorage range or ship speeds are greater than a predetermined speed;
grouping the ship trajectories according to the Maritime Mobile Service Identity (MMSI) identification code to obtain the ship trajectory of each of the ships; and
storing the trajectory points of each of the ship trajectories of each of the ships in time sequence.

Furthermore, the step of screening out the ship trajectories including the anchoring process and eliminating the trajectory points in the non-anchored state in the ship trajectories including the anchoring process to obtain the anchoring trajectories of the anchored ships comprises:
traversing each of the ship trajectories through a sliding window of a predetermined size; calculating an average ship speed of trajectory points in any one of trajectory intervals of each of the ship trajectories of each of the ships during a sliding process of the sliding window; determining whether the trajectory intervals of each of the ship trajectories comprise a trajectory interval where an average ship speed of the trajectory interval is less than a speed threshold value; if yes, determining that a corresponding ship comprises an anchoring process and removing other trajectory intervals in a corresponding ship trajectory where the average ship speed is less than the speed threshold value; and obtaining the anchoring trajectory of the corresponding ship, if not, determining that the corresponding ship does not comprise the anchoring process.

Furthermore, the step of clustering the anchoring points in each of the anchoring trajectories, and using the cluster center of the anchoring points of each of the anchoring trajectories as the anchoring position point of each of the anchored ships comprises;
obtaining the cluster center of the anchoring points of each of the anchoring trajectories based on a K-means clustering algorithm to obtain the anchoring point of each of the anchored ships

Furthermore, the step of establishing the anchoring data set according to the anchoring position point of each of the anchored ships comprises:
recording an anchoring position, a length of the anchored ship, a ship type, an anchor drop time, and an anchor lift time of each of the anchored ships to obtain the anchoring data record of each of the anchored ships; and
establishing the anchoring data set according to the anchoring data record of each of the anchored ships.

Furthermore, determining the congestion level of the ships in the anchorage based on the comparison result of the anchoring area of the corresponding anchored ship and the threshold specification area comprises steps:
when an anchoring area of any one of the ships is less than the threshold specification area, determining that the one of the ships is in a crowded state; and
when a proportion of ships in the crowded state of all the ships in the anchorage is greater than a preset proportion, determining that the anchorage is in the crowded state, and when the proportion of the ships in the crowded state of all the ships in the anchorage is not greater than the preset proportion, determining that the anchorage is not in the crowded state,

Furthermore, the step of when the proportion of the ships in the crowded state of all the ships in the anchorage is greater than the preset proportion, determining that the anchorage is in the crowded state comprises:
determining the congestion level of the ships in the anchorage according to a value of the preset proportion.

The preset proportion comprises a first preset proportion, a second preset proportion and a third preset proportion. A value of the first preset proportion, a value of the second preset proportion, and a value of the third preset proportion increase in sequence.

Furthermore, the step of determining the utilization rate of the anchorage based on the comparison result of the anchoring area of the corresponding anchored ship and the threshold specification area comprises steps:
when the anchoring area of any one of the ships is less than the threshold specification area, taking an area of a corresponding Thiessen polygon as the anchoring area of the one of the ships;
when the anchoring area of any one of the ships is not less than the threshold specification area, taking the threshold specification area as the anchoring area of the one of the ships; and
determining a ratio of anchoring areas of all the ships to the anchorage as the utilization rate of the anchorage.

Furthermore, the method further comprises steps:
when it is determined that the anchorage is in the crowded state, determining a target ship from the ships in the anchorage; and
notifying the target ship, by a radio signal, to perform safety measures.

Furthermore, the step of notifying the target ship, by the radio signal, to perform the safety measures comprises:
controlling a light device of the target ship to emit a light signal; and
controlling the target ship to move to a safe watersand.

The step of controlling the light device of the target ship to emit the light signal comprises: turning on searchlights of the target ship, or turning on lights for deck lighting of the target ship.

Furthermore, an anchorage area of the target ship is less than the threshold specification area.

The present disclosure further provides a device for calculating the anchoring area of the ship. The device comprises a processor and a memory. A computer program is stored on the memory. When the computer program is executed by the processor, the method for evaluating the anchorage state is implemented.

The present disclosure further provides a computer storage medium. The computer storage medium comprises a computer program stored in the computer storage medium. When the computer program is executed by a processor, the method for evaluating the anchorage state is implemented.

In the present disclosure, the ship trajectories that do not comprise the anchored state are firstly screened out. Further, the trajectory points in the non-anchored state in the ship trajectories that comprise the anchored state are screened out to obtain the anchoring trajectories of the anchored ships in the anchored state, so as to select the anchored ships in the anchored state, which is convenient for subsequent calculation of the anchoring area of each of the anchored ships. Then, the anchoring process of each of the anchored ships are clustered and each cluster center is used as the anchoring position of each of the anchored ships, which realizes extraction of the anchoring positions. Finally, the anchored ship position point set in the predetermined time period is established and Thiessen polygons one-to-one corresponding to the anchoring points in the anchored ship position point set is described as the anchoring areas of the corresponding anchored ships, By calculating an area of each of the Thiessen polygons, the anchoring area of each of the anchored ships is obtained. The method for calculating the anchoring area of the ship proposed by the present disclosure effectively measures a size of the anchoring area, and thereby evaluating utilization of the anchorage and the safety of the ship at the anchorage. Compared with the prior art, the method for calculating the anchoring area of the ship proposed by the present disclosure has advantages of dynamic, fast and accurate.

### BRIEF DESCRIPTION OF DRAWINGS

FIG. 1 is a flow chart of a method for evaluating an anchorage state according to a first embodiment of the present disclosure.

FIG. 2 is a schematic diagram of anchoring trajectories obtained by the method for evaluating the anchorage state according to the first embodiment of the present disclosure.

FIG. 3 is a schematic diagram of a clustering result obtained by the method for evaluating the anchorage state according to the first embodiment of the present disclosure.

FIG. 4 is a schematic diagram of an anchored ship position point set obtained by the method for evaluating the anchorage state according to the first embodiment of the present disclosure.

FIG. 5 is a schematic diagram of Thiessen polygons obtained by the method for evaluating the anchorage state according to the first embodiment of the present disclosure.

FIG. 6 is a schematic diagram of calculating an anchoring area of an anchored ship by the method for evaluating the anchorage state according to the first embodiment of the present disclosure.

FIG. 7 is a graph of a congestion level of ships in an anchorage obtained by the method for evaluating the anchorage state according to the first embodiment of the present disclosure.

FIG. 8 is a graph of a utilization rate of the anchorage obtained by the method for evaluating the anchorage state according to the first embodiment of the present disclosure.

FIG. 9 is a schematic diagram of a device for calculating an anchoring area of a ship and a ship according to a second embodiment of the present disclosure.

### DETAILED DESCRIPTION

The optional embodiments of the present disclosure are specifically described below with reference to the accompanying drawings. The accompanying drawings form a part of the present disclosure, and together with the embodiments of the present disclosure, are used to explain the principles of the present disclosure, instead of limiting the scope of the present disclosure.

### Embodiment 1

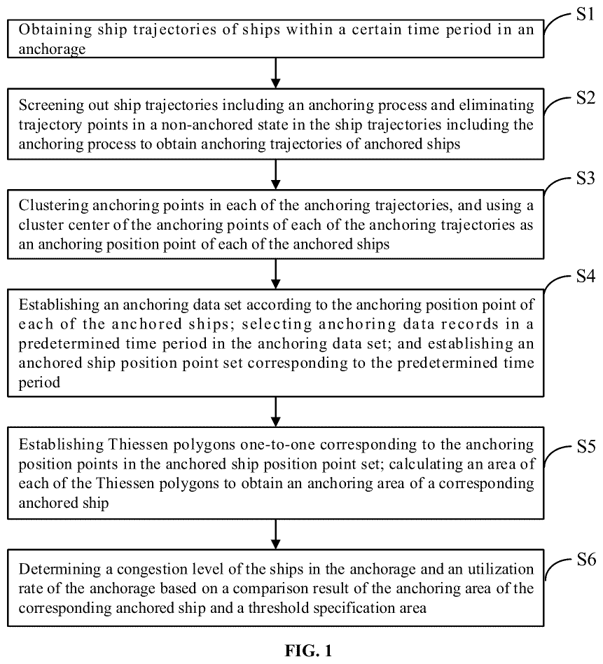

As shown in FIG. 1, the present disclosure provides a method for calculating an anchoring area of a ship. The method comprises steps S1-S6.

The step S1 comprises obtaining ship trajectories of ships within a certain time period in an anchorage from a local Vessel Traffic Service system (VTS).

The step S2 comprises screening out ship trajectories including an anchoring process and eliminating trajectory points in a non-anchored state in the ship trajectories including the anchoring process to obtain anchoring trajectories of anchored ships.

The step S3 comprises clustering anchoring points in each of the anchoring trajectories, and using a cluster center of the anchoring points of each of the anchoring trajectories as an anchoring position point of each of the anchored ships.

The step S1 comprises establishing an anchoring data set according to the anchoring position point of each of the anchored ships; selecting anchoring data records in a predetermined time period in the anchoring data set; and establishing an anchored ship position point set corresponding to the predetermined time period.

The step S5 comprises establishing Thiessen polygons one-to-one corresponding to the anchoring position points in the anchored ship position point set; calculating an area of each of the Thiessen polygons to obtain an anchoring area of a corresponding anchored ship.

The step S6 comprises determining a congestion level of the ships in the anchorage and a utilization rate of the anchorage based on a comparison result of the anchoring area of the corresponding anchored ship and a threshold specification area.

It should be noted that the method for elevating the anchorage state of the embodiment of the present disclosure is configured to be executed in a software system, which may be a maritime waters safety supervision system. The maritime waters safety supervision system is configured to be executed on a terminal such as a device 10 for calculating an anchoring area of a ship shown in FIG. 9. The device 10 for calculating the anchoring area of the ship may be a personal computer (PC) terminal, a mobile terminal, or a portable terminal, etc.

It should be noted that the device 10 includes a processor 110, a memory 120, a display 130, and a communication module 140. FIG. 9 only shows some components of the device 10, and it should be understood that it is not required to implement the method by all the components shown in FIG. 9, and more or fewer components are also capable of implementing the method.

In some embodiments, the processor 110 may be a central processing unit (CPU), a microprocessor, or other data processing chip. The processor 110 is configured to run program codes stored in the memory 120 or process data, such as execute the method of the present disclosure.

In some embodiments of the present disclosure, the processor 110 may be a single server or a server group. The server group may be centralized or distributed. In some embodiments, the processor 110 may be a local processor or a remote processor. In some embodiments, the processor 110 may be implemented on a cloud platform. In one embodiment, the cloud platform may include a private cloud, a public cloud, a hybrid cloud, a community cloud, a distributed cloud, an internal cloud, a multi-cloud, etc., or any combination thereof.

In some embodiments, the memory 120 may be an internal storage unit of the device 10, such as a hard disk or memory of the device 10.

Furthermore, the memory 120 may include both an internal storage unit of the device 10 and an external storage device. The memory 120 is configured to store application software and various data installed on the device 10.

In some embodiments, the display 130 may be an LED display, a liquid crystal display, a touch-sensitive liquid crystal display, and an organic light emitting diode (OLED) touch device. The display 130 is configured to display information of the device 10 and to display a visual user interface. The components 110-130 of the device 10 are communicated with each other via a system bus. It should further be noted that the embodiment of the present disclose is able to be applied to evaluate a anchorage state of a river, and is particularly suitable for evaluating an anchorage state of a main line of the Yangtze River.

The embodiment of the present disclosure starts with the ship trajectory data and the spatial analysis method, and proposes a calculation method for constructing the anchoring areas of the anchored ships based on the Voronoi diagram (i.e., the Thiessen polygons). In the present disclosure, the ship trajectories that do not comprise the anchored state are firstly screened out. Further, the trajectory points in the non-anchored state in the ship trajectories that comprise the anchored state are screened out to obtain the anchoring trajectories of the anchored ships in the anchored state, so as to select the anchored ships in the anchored state, which is convenient for subsequent calculation of the anchoring area of each of the anchored ships. Then, the anchoring process of each of the anchored ships are clustered and each cluster center is used as the anchoring position of each of the anchored ships, which realizes extraction of the anchoring positions. Finally, the anchored ship position point set in the predetermined time period is established and Thiessen polygons one-to-one corresponding to the anchoring points in the anchored ship position point set is described as the anchoring areas of the corresponding anchored ships, By calculating an area of each of the Thiessen polygons, the anchoring area of each of the anchored ships is obtained.

The method for calculating the anchoring area of the ship proposed by the present disclosure effectively measure a size of the anchoring area, and thereby evaluating utilization of the anchorage and the safety of the ship at the anchorage. Compared with the prior art, the method for calculating the anchoring area of the ship proposed by the present disclosure has advantages of dynamic, fast and accurate.

Optionally, the step of obtaining the ship trajectories of the ships within the certain time period in the anchorage comprises:
obtaining Automatic Identification System (AIS) data of each of the ships within the certain time period in the anchorage; wherein the AIS data of each of the ships comprises static information and dynamic information; the dynamic information of each of the ships comprises ship position information, ship speed information, and heading information; and
generating the ship trajectories according to the ship position information, the ship speed information, and the heading information of each of the ships; and marking each of the ship trajectories of each of the ships based on the static information of each of the ships.

Ship AIS system refers to a type of navigation aid system applied to maritime safety and communication between ship and shore, ship and ship. The AIS system generally comprises a Very High Frequency (VHF) communication machine, a GPS locator, and a communication controller communicated with onboard display and sensors. The AIS system is configured to automatically exchange important information such as ship position information, ship speed information, heading information, ship name information, and call sign information with an external device. The AIS system installed on the ship also receives information of other ships within coverage of the VHF communication machine while sending the information to the outside, thus realizing the automatic response.

In the embodiment, the AIS data is collected and provided by the AIS system on each of the ships. The AIS system provides static information and dynamic information of a corresponding ship. The static information comprises the name of the corresponding ship, the Maritime Mobile Service Identify (MMSI) number, the ship type, and the size of the corresponding ship. The dynamic information comprises ship position information (longitude and latitude coordinates of the corresponding ship), ship speed information, heading information, timestamp information, etc. In the embodiment, the obtained AIS data of the corresponding ship is configured to generate a corresponding ship trajectory of the ship trajectories, which is configured for subsequent acquisition of ship trajectory data of the anchored ships. When one ship is anchored, one piece of AIS data is obtained in about 3 minutes. With popularization and application of the AIS systems, a large amount of the ship trajectory data of the anchored ships are accumulated.

Optionally, the step of obtaining the ship trajectories of the ships within the certain time period in the anchorage further comprises:
screening out and eliminating the trajectory points in the ship trajectories where ship positions are not within a predetermined anchorage range or ship speeds are greater than a predetermined speed;
grouping the ship trajectories according to the Maritime Mobile Service Identify (MMSI) identification code to obtain the ship trajectory of each of the ships; and
storing the trajectory points of each of the ship trajectories of each of the ships in time sequence.

Specifically, the obtained ship trajectory data is preprocessed. After removing obvious abnormal data in the ship position and ship speed, the ships are grouped according to the MMSI identification code of the ships to obtain the ship trajectory data of each of the ships, and then the ship trajectory data is stored according to the time sequence.

Optionally, the step of screening out the ship trajectories including the anchoring process and eliminating the trajectory points in the non-anchored state in the ship trajectories including the anchoring process to obtain the anchoring trajectories of the anchored ships comprises:
traversing each of the ship trajectories through a sliding window of a predetermined size; calculating an average ship speed of trajectory points in any one of trajectory intervals of each of the ship trajectories of each of the ships during a sliding process of the sliding window; determining whether the trajectory intervals of each of the ship trajectories comprise a trajectory interval where an average ship speed of the trajectory interval is less than a speed threshold value; if yes, determining that a corresponding ship comprises an anchoring process and removing other trajectory intervals in a corresponding ship trajectory where the average ship speed is less than the speed threshold value; and obtaining the anchoring trajectory of the corresponding ship, if not, determining that the corresponding ship does not comprise the anchoring process.

In the embodiment, the preprocessed ship trajectory data is configured for anchoring identification through a sliding window algorithm. The sliding window of the predetermined size is selected to traverse each of the ship trajectories. The average ship speed v of trajectory points in each of the trajectory intervals during the sliding process of the sliding window is calculated. The speed threshold value vₜₕ is given and is configured to be compared with the average ship speed v of each of the trajectory intervals. If the trajectory intervals of each of the ship trajectories comprise the trajectory interval where the average ship speed of the trajectory interval is less than the speed threshold value; it is determined that the corresponding ship comprises the anchoring process and then the trajectory intervals of the ship trajectories of the ships where the average ship speed is less than the speed threshold value are extracted to obtain the anchoring trajectories of the anchored ships. If the ship trajectory of the corresponding ship does not comprise the period where the average ship speed of the period is less than the speed threshold value, it is determined that the corresponding ship does not comprise the anchoring process and the ship trajectory of the corresponding ship is removed.

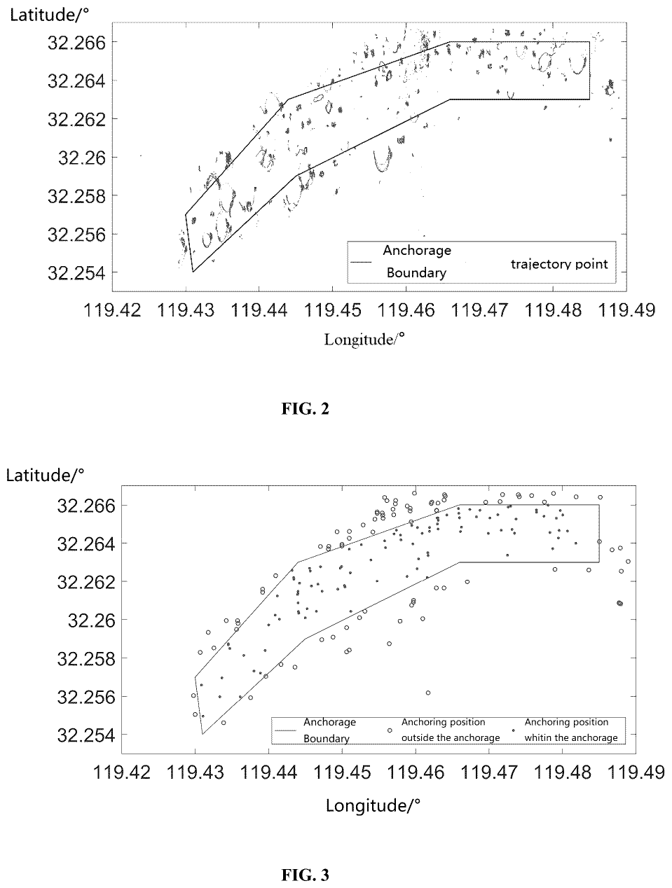

After the state of each of the ships is iteratively obtained, the trajectory points in the non-anchored state are eliminated to form the anchoring trajectory data of all anchored ships, as shown in FIG. 2.

Optionally, the step of clustering the anchoring points in each of the anchoring trajectories, and using the cluster center of the anchoring points of each of the anchoring trajectories as the anchoring position point of each of the anchored ships comprises;
obtaining the cluster center of the anchoring points of each of the anchoring trajectories based on a K-means clustering algorithm to obtain the anchoring point of each of the anchored ships

It should be understood that different clustering algorithms can be used to cluster the anchoring points in each of the anchoring trajectories. In the embodiment, as shown in FIG. 3, the K-means clustering algorithm is configured to perform density clustering on the trajectory points to obtain the cluster centers configured as the anchoring position points of the anchored ships.

Optionally, the step of establishing the anchoring data set according to the anchoring position point of each of the anchored ships comprises:
recording an anchoring position, a length of the anchored ship, a ship type, an anchor drop time, and an anchor lift time of each of the anchored ships to obtain the anchoring data record of each of the anchored ships; and
establishing the anchoring data set according to the anchoring data record of each of the anchored ships.

Specifically, the anchoring position, the length of the anchored ship, the ship type, the anchor drop time, and the anchor lift time of each of the anchored ships are recorded to obtain the anchoring data set of the anchored ships

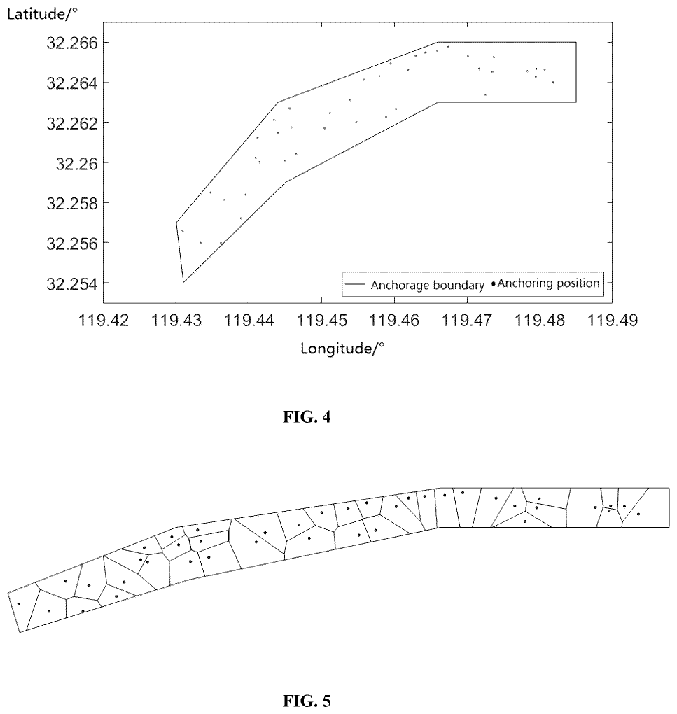

According to the anchoring data set, with a predetermined time period (e.g., in a unit of hour)., the anchoring ship data in each hour of the anchoring data set is selected to construct a corresponding anchored ship position point set. As shown in FIG. 4, it shows the anchored ship position point set in one hour.

A Voronoi area in a shape of a convex polygon is assigned to each of the anchoring position points in FIG. 4, and the Thiessen polygons of some anchoring position points are shown in FIG. 5.

In the embodiment of the present disclosure, determining the congestion level of the ships in the anchorage based on the comparison result of the anchoring area of the corresponding anchored ship and the threshold specification area comprises steps:
when an anchoring area of any one of the ships is less than the threshold specification area, determining that the one of the ships is in a crowded state; and
when a proportion of ships in the crowded state of all the ships in the anchorage is greater than a preset proportion, determining that the anchorage is in the crowded state, and when the proportion of the ships in the crowded state of all the ships in the anchorage is not greater than the preset proportion, determining that the anchorage is not in the crowded state,

Specifically, if the anchorage area of the one of the ships is too small, then the anchoring area of the one of the ships is significantly less than the threshold specification area, indicating that the one of the ships is in the crowded state. In order to avoid the anchorage area of any one of the ships being too small, risk mitigation measures such as shifting of the one of the ships are required.

It should be noted that the threshold specification area is calculated according to the following formula:

$${A}_{M} = S \times a$$

In the formula, Am represents the anchoring area (m²). S represents a length of an anchoring space of the single ship along a water flow direction (m). a represents a width of the anchoring space (m).

Furthermore, the length of the anchoring space along the water flow direction and the width of the anchoring space are calculated based on a length (L) and a width

(B) of a specific anchored ship, as shown in the following table (specifically, n represents the number of the barges anchored side by side):

| Position | Anchored type | Length | Width |
|---|---|---|---|
| River sections less | Large barge | (1.6~2.0) L | (4.0~4.5) B |
| affected by wind | Small barge | (1.6~2.0) L | [n′ + (2~3)]B |
| and waves | | | |
| River sections that | Large barge | (2.5~3.0) L | (6.0~4.5) B |
| are greatly | Small barge | (2.0~2.6) L | [n′ + (2~3)]B |
| affected by wind, | | | |
| waves, and tides | | | |

(Table 1 of length and width of an anchoring space)

In the embodiment, the step of when the proportion of the ships in the crowded state of all the ships in the anchorage is greater than the preset proportion, determining that the anchorage is in the crowded state comprises:
determining the congestion level of the ships in the anchorage according to a value of the preset proportion.

The preset proportion comprises a first preset proportion, a second preset proportion and a third preset proportion. A value of the first preset proportion, a value of the second preset proportion, and a value of the third preset proportion increase in sequence.

Specifically, the value of the first preset proportion, the value of the second preset proportion, and the value of the third preset proportion may be 25%, 50%, 75%, etc., which respectively represent that the anchorage is in a general crowed state, a moderate crowed state, and a serious crowed state.

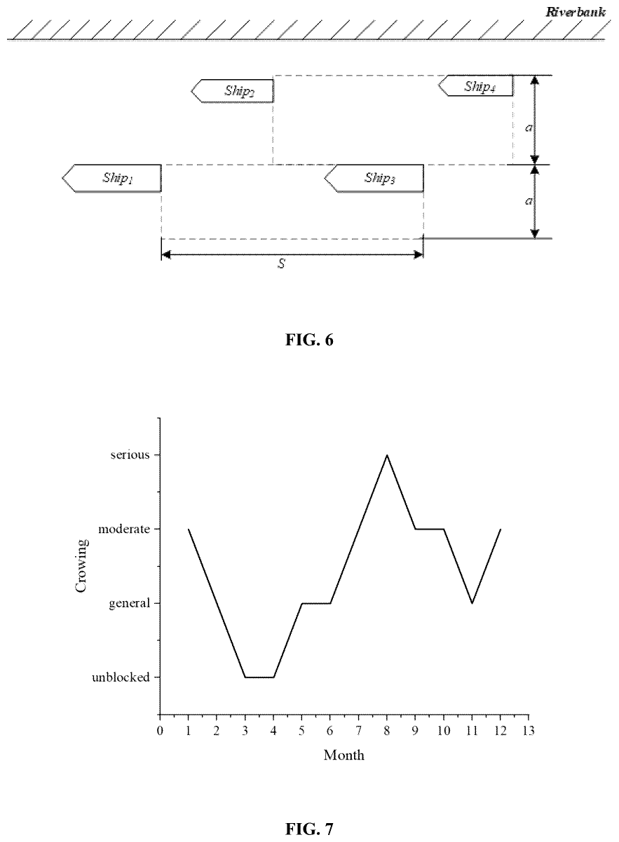

In some embodiments, in order to more accurately determine the congestion level of the ships, it is also necessary to adopt an evaluation method within a time period, such as through weekly, monthly, and annual statistical methods. The evaluation method within a time period is configured to comprehensively understand the congestion level of the ships in a statistical manner, providing a data basis for subsequent ship safety protection. Specifically, as shown in FIG. 7, which shows the curve representing the crowed state of the anchorage formed within a 1-year cycle. It is found from FIG. 7 that the congestion level of the anchorage is significantly different in different months, which indirectly reflects the transportation law of the ships in that month and provide data reference for subsequent reasonable scheduling.

In the embodiment of the present disclosure, the step of determining the utilization rate of the anchorage based on the comparison result of the anchoring area of the corresponding anchored ship and the threshold specification area comprises steps:
when the anchoring area of any one of the ships is less than the threshold specification area, taking an area of a corresponding Thiessen polygon as the anchoring area of the one of the ships;
when the anchoring area of any one of the ships is not less than the threshold specification area, taking the threshold specification area as the anchoring area of the one of the ships; and
determining a ratio of anchoring areas of all the ships to the anchorage as the utilization rate of the anchorage.

Specifically, when the anchoring area of any one of the ships is less than the threshold specification area, taking the area of the corresponding Thiessen polygon as the anchoring area of the one of the ships;. When the anchoring area of any one of the ships is not less than the threshold specification area, taking the threshold specification area as the anchoring area of the one of the ships; Generally, the ratio of anchoring areas of all the ships to the anchorage is configured as the utilization rate of the anchorage.

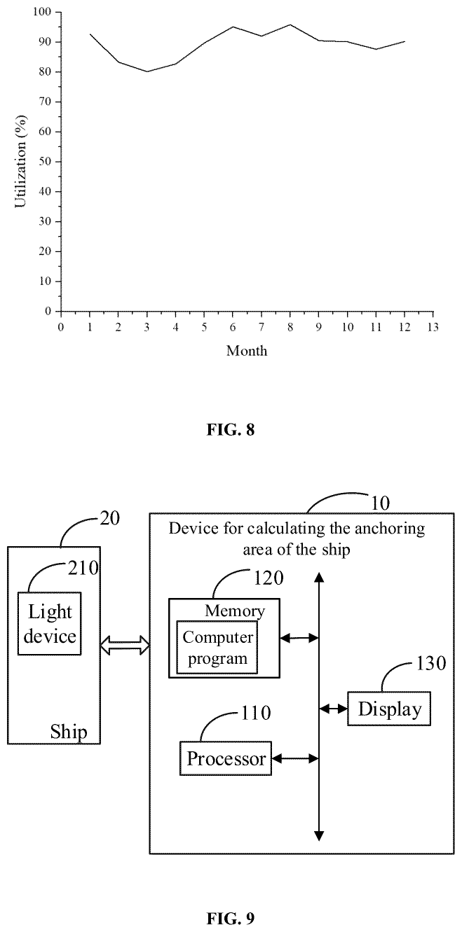

Furthermore, in order to more accurately determine the utilization rate of the anchorage, it is also necessary to adopt the evaluation method within the time period, to comprehensively understand the utilization rate of the anchorage, thereby providing reference for subsequent anchorage planning. Specifically, as shown in FIG. 8, which shows the curve representing the utilization rate of the anchorage formed within a 1-year cycle. It is found from FIG. 8 that the utilization rate of the anchorage is significantly different in different months, which indirectly reflects the utilization situations of the anchorage in that month and provide data reference for subsequent maritime supervision.

Furthermore, combining FIGS. 7-8, the method proposed in the present disclosure may be integrated into a water safety supervision system of a current maritime administration department as an “anchorage operation management and evaluation” module, and a background terminal is configured to receive the ship data transmitted by AIS. The anchoring area of each anchored ship is calculated based on the method, and an area calculation result thereof is configured for dynamic evaluation of the congestion level and the utilization rate of the anchorage. The evaluation result is transmitted to a display screen terminal of the administration department or the mobile terminal of a supervisor in a form of a curve chart (such as the curves shown in FIGS. 7-8) for visual display, so as to provide data support and auxiliary decision-making.

Taking the result shown in FIGS. 7-8 as an example, the anchorage is basically in the crowed state.

Specifically, the number of months when the anchorage is in the general crowded state accounts for 4 months, and the number of months when the anchorage is the moderate crowded state or even is 6 months, and the utilization rate of the anchorage is above 80% all year round. Based on the result, the marine administration department and relevant personnel may use strategies such as ship shifting or berthing guides in the months when the anchorage is in the crowded state, so that the ships are anchored reasonably or some of the ships may go to other slightly freer anchorages to anchor. Furthermore, it is also possible to consider increasing an occupied space of the anchorage or planning and building new anchorages to ensure the safety of ships and the efficient operation of the anchorage.

In the embodiment of the present disclosure, the method further comprises steps:
when it is determined that the anchorage is in the crowded state, determining a target ship from the ships in the anchorage; and
when it is determined that the anchorage is in the crowded state, determining a target ship from the ships in the anchorage; and
notifying the target ship, by a radio signal, to perform safety measures.

Furthermore, the step of notifying the target ship, by the radio signal, to perform the safety measures comprises:
controlling a light device of the target ship to emit a light signal; and
controlling the target ship to move to a safe watersand.

The step of controlling the light device of the target ship to emit the light signal comprises: turning on searchlights of the target ship, or turning on lights for deck lighting of the target ship. The step of controlling the light device of the target ship to emit the light signal comprises: turning on searchlights of the target ship, or turning on lights for deck lighting of the target ship.

Specifically, as shown in FIG. 9, the light device 210 is disposed in each of the ships. After receiving the radio signal, the target ship needs to move out of the corresponding anchoring area to other safe watersand, such as another anchorage. At this time, since the anchorage where the target ship is currently located is in the crowded state and there may be other ships anchored around the target ship, in order to ensure that the target ship is able to smoothly move out of the anchoring area, the light device 210 on the target ship 20 is turned on. The light device 210 comprises at lest one warning light that is configured for warning. For example, the light device 210 may be searchlights on the target ship 20, or lights for deck lighting. At this time, staff on the ships around the target ship can understand that the target ship is about to move. Therefore, the target ship maintain a safe distance from other ships, ensuring that the target ship smoothly moves out of the anchoring area. During movement of the ship, the lighting device 210 on the target ship is turned off and navigation lights are turned on until the target ship reaches a next anchorage. Furthermore, the ships 20 are communicated with the device 10 through a wireless network, and each of the ships 20 only needs to be equipped with a communication device having a communication function.

In the embodiment of the present disclosure, an anchorage area of the target ship is less than the threshold specification area.

In addition, the radio signal is sent out by the VTS, and the VHF communication machine of the AIS system of the target ship is able to automatically send and receive radio signals. After the target ship receives the radio signal, the lighting device 210 is turned on to notice surrounding ships, and then the target ship starts to move.

In the embodiment of the present disclosure, identification and screening process of the anchored states of the ships is firstly performed based on the sliding window. Then the anchoring positions of the anchored ships are obtained based on the clustering algorithm. Finally, the anchoring area of a single ship is constructed based on the Voronoi diagram to realize the calculation of the anchoring area of each of the anchored ships. The method for calculating the anchoring area of the ship proposed by the present disclosure effectively measure a size of the anchoring area, and thereby evaluating utilization of the anchorage and the safety of the ship at the anchorage. Compared with the prior art, the method for calculating the anchoring area of the ship proposed by the present disclosure has advantages of dynamic, fast and accurate.

### Embodiment 2

Embodiment 2 of the present disclosure provides a device 10 for calculating the anchoring area of the ship. The device comprises a processor 110 and a memory 120. A computer program is stored on the memory 120. When the computer program is executed by the processor 110, the method for evaluating the anchorage state mentioned in Embodiment 1 is implemented.

The device 10 for calculating the anchoring area of the ship of the embodiment of the present disclosure is configured to carry out the method for evaluating the anchorage state. Therefore, technical effects possessed by the method for calculating the anchoring area of the ship is also possessed by the device for calculating the anchoring area of the ship, which are not repeated herein.

### Embodiment 3

Embodiment 3 of the present disclosure provides a computer storage medium. The computer storage medium comprises a computer program stored in the computer storage medium. When the computer program is executed by a processor, the method for evaluating the anchorage state mentioned in Embodiment 1 is implemented.

The computer storage medium of the embodiment of the present disclosure is configured to carry out the method for evaluating the anchorage state. Therefore, technical effects possessed by the method for evaluating the anchorage state is also possessed by the computer storage medium, which are not repeated herein.

Foregoing descriptions are only optional embodiments of the present disclosure and are not intended to limit the present disclosure. Any modification, equivalent replacement, or improvement within the technical scope of the present disclosure made by those skilled in the art should be included in the protection scope of the present disclosure.

What is claimed is:

1. A method for evaluating an anchorage state, comprising steps:
obtaining ship trajectories of ships within a certain time period in an anchorage;
screening out ship trajectories including an anchoring process and eliminating trajectory points in a non-anchored state in the ship trajectories including the anchoring process to obtain anchoring trajectories of anchored ships;
clustering anchoring points in each of the anchoring trajectories, and using a cluster center of the anchoring points of each of the anchoring trajectories as an anchoring position point of each of the anchored ships;
establishing an anchoring data set according to the anchoring position point of each of the anchored ships; selecting anchoring data records in a predetermined time period in the anchoring data set; and establishing an anchored ship position point set corresponding to the predetermined time period;
establishing Thiessen polygons one-to-one corresponding to the anchoring position points in the anchored ship position point set; calculating an area of each of the Thiessen polygons to obtain an anchoring area of a corresponding anchored ship; and
determining a congestion level of the ships in the anchorage and a utilization rate of the anchorage based on a comparison result of the anchoring area of the corresponding anchored ship and a threshold specification area;
wherein determining the congestion level of the ships in the anchorage based on the comparison result of the anchoring area of the corresponding anchored ship and the threshold specification area comprises steps:
when an anchoring area of any one of the ships is less than the threshold specification area, determining that the one of the ships is in a crowded state; and
when a proportion of ships in the crowded state of all the ships in the anchorage is greater than a preset proportion, determining that the anchorage is in the crowded state, and when the proportion of the ships in the crowded state of all the ships in the anchorage is not greater than the preset proportion, determining that the anchorage is not in the crowded state,
wherein the method further comprises steps:
when it is determined that the anchorage is in the crowded state, determining a target ship from the ships in the anchorage; and
notifying the target ship, by a radio signal, to perform safety measures.

2. The method according to claim 1, wherein the step of obtaining the ship trajectories of the ships within the certain time period in the anchorage comprises:
obtaining Automatic Identification System (AIS) data of each of the ships within the certain time period in the anchorage; wherein the AIS data of each of the ships comprises static information and dynamic information; the dynamic information of each of the ships comprises ship position information, ship speed information, and heading information; and
generating the ship trajectories according to the ship position information, the ship speed information, and the heading information of each of the ships; and marking each of the ship trajectories of each of the ships based on the static information of each of the ships.

3. The method according to claim 2, wherein the step of obtaining the ship trajectories of the ships within the certain time period in the anchorage further comprises:
screening out and eliminating the trajectory points in the ship trajectories where ship positions are not within a predetermined anchorage range or ship speeds are greater than a predetermined speed;
grouping the ship trajectories according to the Maritime Mobile Service Identify (MMSI) identification code to obtain the ship trajectory of each of the ships; and
storing the trajectory points of each of the ship trajectories of each of the ships in time sequence.

4. The method according to claim 1, wherein the step of screening out the ship trajectories including the anchoring process and eliminating the trajectory points in the non-anchored state in the ship trajectories including the anchoring process to obtain the anchoring trajectories of the anchored ships comprises:
traversing each of the ship trajectories through a sliding window of a predetermined size; calculating an average ship speed of trajectory points in any one of trajectory intervals of each of the ship trajectories of each of the ships during a sliding process of the sliding window; determining whether the trajectory intervals of each of the ship trajectories comprise a trajectory interval where an average ship speed of the trajectory interval is less than a speed threshold value; if yes, determining that a corresponding ship comprises an anchoring process and removing other trajectory intervals in a corresponding ship trajectory where the average ship speed is less than the speed threshold value; and obtaining the anchoring trajectory of the corresponding ship, if not, determining that the corresponding ship does not comprise the anchoring process.

5. The method according to claim 1, wherein the step of clustering the anchoring points in each of the anchoring trajectories, and using the cluster center of the anchoring points of each of the anchoring trajectories as the anchoring position point of each of the anchored ships comprises;
obtaining the cluster center of the anchoring points of each of the anchoring trajectories based on a K-means clustering algorithm to obtain the anchoring point of each of the anchored ships.

6. The method according to claim 1, wherein the step of establishing the anchoring data set according to the anchoring position point of each of the anchored ships comprises:
recording an anchoring position, a length of the anchored ship, a ship type, an anchor drop time, and an anchor lift time of each of the anchored ships to obtain the anchoring data record of each of the anchored ships; and
establishing the anchoring data set according to the anchoring data record of each of the anchored ships.

7. The method according to claim 1, wherein the step of when the proportion of the ships in the crowded state of all the ships in the anchorage is greater than the preset proportion, determining that the anchorage is in the crowded state comprises:
determining the congestion level of the ships in the anchorage according to a value of the preset proportion;
wherein the preset proportion comprises a first preset proportion, a second preset proportion and a third preset proportion, and a value of the first preset proportion, a value of the second preset proportion, and a value of the third preset proportion increase in sequence.

8. The method according to claim 1, wherein determining the utilization rate of the anchorage based on the comparison result of the anchoring area of the corresponding anchored ship and the threshold specification area comprises steps:
when the anchoring area of any one of the ships is less than the threshold specification area, taking an area of a corresponding Thiessen polygon as the anchoring area of the one of the ships;
when the anchoring area of any one of the ships is not less than the threshold specification area, taking the threshold specification area as the anchoring area of the one of the ships; and
determining a ratio of anchoring areas of all the ships to the anchorage as the utilization rate of the anchorage.

9. The method according to claim 1, wherein the step of notifying the target ship, by the radio signal, to perform the safety measures comprises:
controlling a light device of the target ship to emit a light signal; and
controlling the target ship to move to a safe watersand;
wherein the step of controlling the light device of the target ship to emit the light signal comprises:
turning on searchlights of the target ship, or turning on lights for deck lighting of the target ship.

10. The method according to claim 1, wherein an anchorage area of the target ship is less than the threshold specification area.

11. A device for calculating an anchoring area of a ship, comprising: a processor and a memory, wherein a computer program is stored on the memory; when the computer program is executed by the processor, the method for evaluating the anchorage state according to claim 1 is implemented.

12. A computer storage medium, comprising: a computer program stored in the computer storage medium; wherein when the computer program is executed by a processor, the method for evaluating the anchorage state according to claim 1 is implemented.
